(19) United States
(12) Patent Application Publication
(10) Pub. No.: US 2007/0281600 A1
(43) Pub. Date: Dec. 6, 2007

(54) Air distribution system having a noise reduction feature for use with an automotive vehicle

(76) Inventors: Prakash Thawani, Bloomfield Hills, MI (US); Jerry Sydlowski, Plymouth, MI (US); Zhengyu Liu, Novi, MI (US)

Correspondence Address: TUNG & ASSOCIATES, 838 WEST LONG LAKE, SUITE 120, BLOOMFIELD HILLS, MI, 48302, US

(21) Appl. No.: 11/443,967

(22) Filed: May 31, 2006

(51) Int. Cl. B60H 3/00; F24F 13/24; F25D 19/00

(52) U.S. Cl. 454/148; 62/296; 165/42; 454/262

(57) ABSTRACT

A method and apparatus for reducing noise levels occurring at a particular frequency in an air distribution apparatus used with an automotive vehicle having an interior compartment. The apparatus includes a noise reduction structure located in the air duct between an inlet end connected to a housing and a discharge end located in the vehicle interior compartment. The noise reduction structure is located a position spaced between the housing and the interior compartment of the automotive vehicle. The particular position of the noise reduction structure is determined based on the frequency of the noise level sought to be reduced. The method includes measuring the frequency of the noise level emitted from the discharge end of the air duct and correspondingly positioning the noise reduction structure at a spacing or distance based on the measured frequency.

### CROSS-REFERENCE TO RELATED APPLICATIONS

Not Applicable.

### BACKGROUND OF THE INVENTION

1. Field of the Invention

The present invention relates generally to an air distribution system for an automobile and more specifically to an air distribution system capable of reducing air rush noise occurring during system use.

2. Description of Related Art

A motor vehicle climate control system or heating, ventilation air-conditioning (HVAC) system typically utilizes an air distribution system including a plurality of ducts. A blower operates to move and control airflow through the system. Air flow noise occurring in the HVAC system, especially at high-speed blower operation; i.e., producing maximum airflow, is a customer comfort concern. Typically, the ducts have a uniform diameter or cross section. Such uniform cross section ducts are prone to excite or form standing sound waves at frequencies corresponding to the duct lengths and plenum chamber dimensions. Typically, the most offensive standing waves are around 150-250 Hertz or higher and produce a subjectively audible rumble or tonal sound, which can coincide with and amplify the inherent vehicle interior modes.

The majority of objectionable noise produced by these lower frequencies is emitted through the air-conditioning or ventilation ductwork into the vehicle interior. Such low frequencies tend to travel through foam insulation. Further, having more energy such low frequencies travel a longer distance in a multitude of directions and thus become audible and correspondingly objectionable in the vehicle interior. Therefore, it would be advantageous to provide an air distribution system including a plurality of system ducts designed with acoustical mode suppression in mind. The design being such that the ducts function to reduce the low-frequency noise or sound emissions transmitted through the air distribution system and in particular the air-conditioning or ventilation duct work.

### SUMMARY OF THE INVENTION

Accordingly, the present invention is an apparatus and method for reducing noise in an air distribution system used with an automotive vehicle having an interior compartment. The apparatus includes a heating, ventilation and air-conditioning housing having at least one inlet for drawing air into the housing and at least one outlet in communication with the housing. An air duct is connected to the outlet located on the housing and receives air from the plenum chamber. A discharge end on the air duct delivers air to the interior compartment of the automotive vehicle. The air duct includes a noise reduction structure located on and spaced between the housing and the discharge end of the air duct wherein the positioning of the noise reduction structure is determined based on the frequency of the noise sought to be reduced.

In one embodiment, multiple noise reduction structures are used and the distance between adjacent noise reduction structures differs such that the air distribution system reduces noise levels occurring at multiple frequencies. In addition, the method contemplates measuring the frequency levels of the noise emitted from the discharge end of the air duct and calculating the spacing between and correspondingly placing or forming adjacent noise reduction structures on the air duct at discreet positions to reduce noise at the measured frequency bands.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is an overall perspective view of the basic components of an automotive air distribution system utilizing an air distribution system according to the present invention.

FIG. 2 is a schematic, cross-sectional view of an air distribution system in accordance with one embodiment of the present invention.

FIG. 3 is a schematic, cross-sectional view of an air distribution system as illustrated in FIG. 2 including additional elements in accordance with one embodiment of the present invention.

FIG. 4 is a schematic, cross-sectional view of an air distribution system in accordance with an alternative embodiment of the present invention.

FIG. 5 is a plot of noise reduction versus frequency of an air distribution system in accordance with one embodiment of the present invention.

FIG. 6 is a cross-sectional view of an air distribution system in accordance with an additional embodiment of the present invention.

### DETAILED DESCRIPTION OF THE PREFERRED EMBODIMENTS

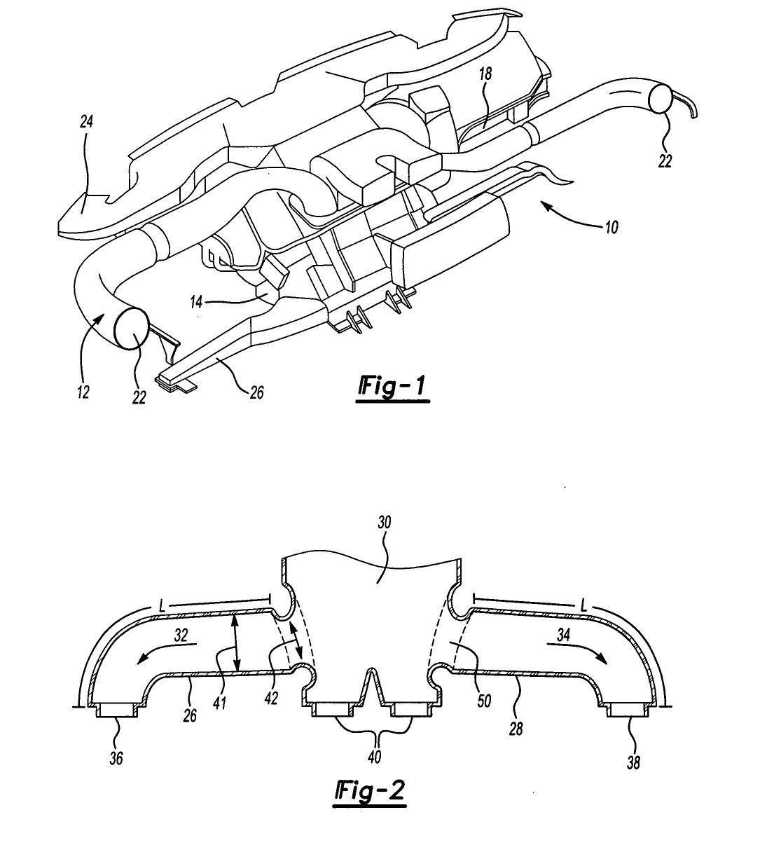

FIG. 1 illustrates a typical heating, ventilation and air-conditioning system (HVAC) 10, including a noise reducing air distribution system, seen generally at 12, according to one embodiment of the present invention. The HVAC system 10 of generally includes a heating, ventilation and air-conditioning housing 14 containing an evaporator core, a heater core and a blower assembly for moving air through the housing 14. Climate control systems utilizing these elements are well known to those skilled in the art and no further explanation is necessary.

The HVAC system 10 may also include a fresh or outside air inlet 16 and a recirculation air inlet 18. The fresh air inlet 16 drawing air from outside the vehicle interior or passenger compartment into the housing 14 and the recirculation air inlet 18 drawing air from inside the vehicle interior or passenger compartment into the housing 14. The blower assembly then moves the air drawn into the housing 14 past the evaporator or heater core and out into the vehicle interior or passenger compartment of the vehicle. As shown, the HVAC system 10 distributes the airflow to a plurality of outlets, including front air-conditioning or ventilation outlets 22 along with defrost and floor oriented heater outlets 24, 26.

Turning now to FIG. 2, there is shown a schematic of a noise reducing air distribution system 12 according to the present invention. As illustrated, left and right air ducts 26, 28 extend from a plenum chamber 30 connected to the housing 14. The left and right air ducts 26, 28 provided a flow path for air traveling in the direction of the arrows 32, 34 from the plenum chamber 30 to respective discharge ends forming the air-conditioning or ventilation outlets of 36, 38. In addition, additional or center air-conditioning or ventilation outlets 40 are attached to the plenum chamber 30. Accordingly, during operation, the blower unit supplies air to the plenum chamber 30 which correspondingly distributes the airflow to the air-conditioning or ventilation outlets 36, 38, 40 and ultimately to the vehicle interior or passenger compartment.

Each of the left and right air ducts 26, 28 is a generally elongated tubular member having a generally constant cross-sectional area 41 perpendicular to the direction of airflow 32, 34. The overall or finite length of each of the respective left and right air ducts 26, 28 may differ depending upon the location of the plenum chamber 30 in the vehicle. In addition, the center air-conditioning or ventilation outlets 40 may also be connected to the plenum chamber 30 using generally elongated tubular members. Again, the overall configuration of the HVAC system 10 including the ductwork thereof is dependent on packaging constraints and air outlet placement.

Depending upon the length, shape and position of the air ducts, the HVAC air distribution system may generate noise at frequencies between 150-600 Hz. Accordingly, the frequencies and amplitude levels of air rush noise occurring in the ductwork due to air flow in the system may be different for each duct or air passage. The present invention controls or reduces the noise by utilizing noise reduction zones or portions that change the cross-section of the duct in a direction normal to the direction of airflow. The noise reduction zones are placed to reduce noise levels occurring at different frequencies.

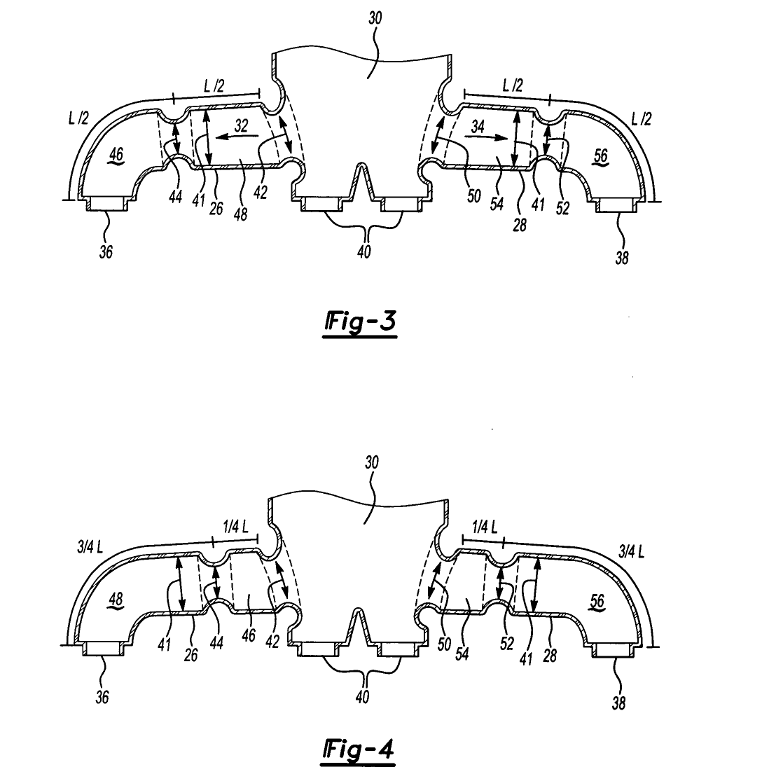

As illustrated in FIGS. 2-3, the left duct 26 has an overall length (L) extending from the plenum chamber 30 to the air-conditioning or ventilation outlet 36. A first reduced cross-sectional area 42 is located at the junction of the left duct 26 and the plenum chamber 30. The first reduced cross-sectional area 42 is formed or constructed such that it maintains laminar or non-turbulent airflow through the left duct 26. Having established an overall length (L) of the left duct 26, a second reduced cross-sectional area 44 is positioned in the left duct 26 and correspondingly divides the left duct 26 into first and second sections 46, 48. As illustrated in FIG. 3, the second reduced cross-sectional area 44 is positioned at a midpoint of the left duct 26 whereby the length of the respective first and second sections 46, 48 are both (L)/2. Accordingly, both the first and second sections 46, 48 of the left duct 26 function to reduce noise amplitude or level at a predetermined frequency.

Keep in mind that the respective lengths of the left and right ducts 26, 28 may differ in lengths, shape and size according to system design. While similar to the left duct 26 in that a first reduced cross-sectional area 50 is positioned between the plenum chamber 30 and the right duct 28, the overall length (L) of the right duct 28 may differ from the overall length (L) of the left duct 26. Accordingly, placing a second reduced cross-sectional area 52 at the midpoint of the right duct 28, that is, between the plenum chamber 30 and the air-conditioning or ventilation outlet 38, results in first and second sections 54, 56 of equal length. While the first and second sections 54, 56 are equal in length, depending upon the overall lengths (L) of the right duct 28, these sections 54, 56 may reduce noise occurring at different frequency levels from those occurring in the left duct 26.

The length of each section and correspondingly the placement of each reduced cross-sectional area is determined based upon the frequency at which the objectionable noise or sound is occurring. Noise reduction chambers maximize sound attenuation at lengths equal to a quarter wavelengths of the frequency sought to be attenuated, wherein F=C/4L or L=C/4F. For example, if the objectionable air rush noise sought to be attenuated occurs at 200 Hz, then the length of the section is calculated as follows: L=(1132 ft/sec)(12 in/ft)/(4)(200) thus L=17 inches. Accordingly, to attenuate or reduce the amplitude of air rush noise occurring in the left air duct 26 at a frequency of 200 Hz, the second reduced cross-sectional area 44 would be placed 17 inches from the first reduced cross-sectional area 42. Thus, depending upon the frequency of the air rush noise, the positioning of the noise reduction portion or reduced cross-sectional areas need not be symmetrical with the left and right ducts 26, 28.

Further, while the first and second sections of the respective ducts are shown separated by reduced cross-sectional areas, an increased cross-sectional area may also be used to separate each of the first and second sections. Such increased cross-sectional areas may be used when packaging constraints for the ducts are not at issue.

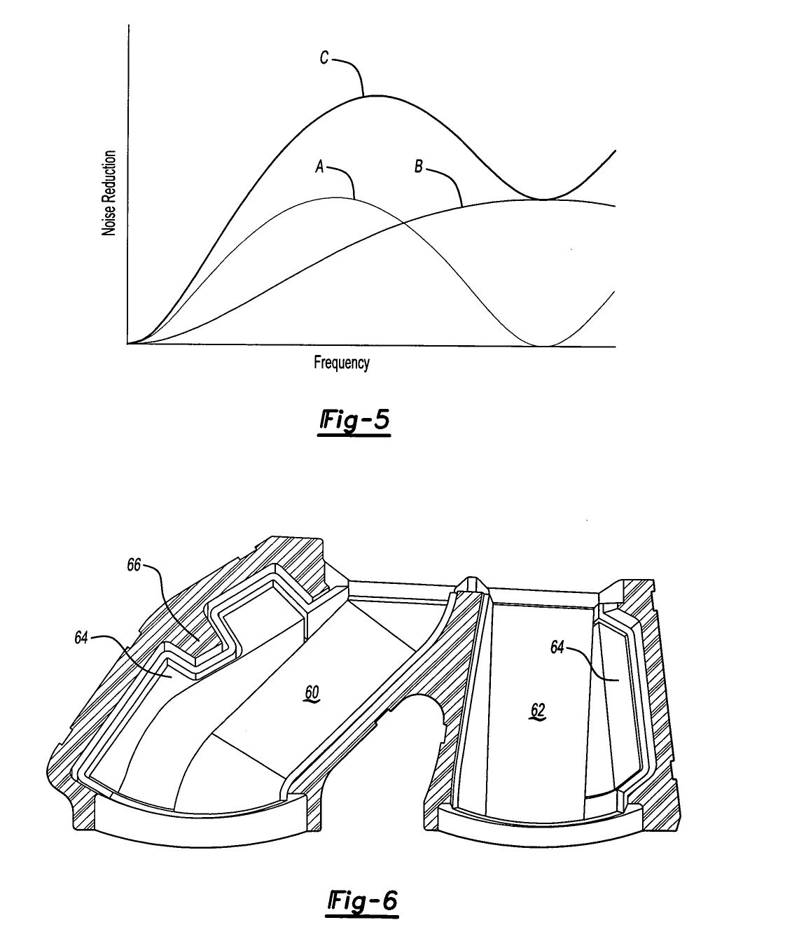

Since the air rush noise, may occur at different and multiple frequency levels in each of the left and right air ducts 26, 28, as illustrated in FIG. 4 it may be advantageous to vary the length of the respective sections to obtain noise amplitude reductions at multiple frequencies. For example, the position of the first reduced cross-sectional area 42 and the second reduce cross-sectional area 44 of the left air duct 26 results in a first section 46 having length of L/4 and the second section 48 having a length of ¾L. Thus, the first and second sections 46, 48 will function to reduce the amplitude of the air rush or flow noise occurring at different frequencies. FIG. 5 illustrates a plot of noise reduction versus frequency according to the present invention. Line A represents noise attenuation for a first section having first length and line B represents noise attenuation for a second section having a second length with line C illustrating the combined or cumulative noise reduction using first and second sections having differing lengths. Using multiple section lengths provides for a broader scope of noise reduction or attenuation since at no location on line C does the noise reduction reach zero. Thus, while dividing each duct 26, 28 into equal lengths doubles the noise reduction at a certain frequency, varying the length of each section, while not providing as great a noise reduction at a discreet frequency, enables a noise reduction or attenuation at various or multiple frequencies.

The present invention contemplates a method for air rush noise or amplitude reduction whereby the frequency of the objectionable airflow noise emitted from the air-conditioning or ventilation outlets is measured. Based on the measured noise frequency, the length of the necessary sections and correspondingly placement of the reduced cross-sectional areas is then calculated.

FIG. 6 shows an additional embodiment of the present invention wherein a resonator 64 is attached to the left or right air of duct 60, 62 whereby the resonator 64 operates to reduce or attenuate objectionable noise. In addition to the resonators 64 added to the air-conditioning or ventilation outlets, the ducts may be made of a soft noise attenuating material. In addition, the resonators 64 may include partitions 66 to vary the size/volume and correspondingly change the noise reduction characteristics of each resonator.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An air distribution apparatus for use with an automotive vehicle having an interior compartment comprising:
a heating, ventilation and air-conditioning housing having at least one inlet and at least one outlet in communication with said housing;
at least one air duct connected to said outlet of said housing, said at least one air duct receiving air from said housing and delivering the air to said interior compartment of the automotive vehicle; and
said air duct including a noise reduction structure located at a position spaced between said housing and said interior compartment of the automotive vehicle wherein said position of said noise reduction structure is selected for noise reduction at a particular frequency.

2. An air distribution apparatus for use with an automotive vehicle having an interior compartment as set forth in claim 1 wherein said air duct has a cross-sectional area and said noise reduction structure includes a portion of said air duct having a cross-sectional area smaller than said cross-sectional area of said air duct.

3. An air distribution apparatus for use with an automotive vehicle having an interior compartment as set forth in claim 1 wherein said air duct has a cross-sectional area and said noise reduction structure includes a portion of said air duct having a cross-sectional area greater than said cross-sectional area of said air duct.

4. An air distribution apparatus for use with an automotive vehicle having an interior compartment as set forth in claim 1 wherein said air duct has a cross-sectional area and said noise reduction structure includes a plurality of portions of said air duct having a cross-sectional area less than said cross-sectional area of said air duct, said portions of said air duct having a cross-sectional area less than said cross-sectional area of said air duct dividing said air duct into sections, each of said sections having a length, the length of each section reducing noise at a particular frequency.

5. An air distribution apparatus for use with an automotive vehicle having an interior compartment as set forth in claim 4 when the length of each section varies to attenuate noise levels emitted at different frequencies.

6. An air distribution apparatus for use with an automotive vehicle having an interior compartment as set forth in claim 1 wherein said air duct has a cross-sectional area and a plurality of noise reduction structures each having a cross-sectional area different from said cross-sectional area of said air duct, said noise reduction structures spaced apart at different lengths from one another to attenuate noise occurring at more than one frequency.

7. An air distribution apparatus for use with an automotive vehicle having an interior compartment as set forth in claim 6 wherein the length of the air duct between respective noise reduction structure structures determines the frequency of the noise to be reduced.

8. An air distribution apparatus for use with an automotive vehicle having an interior compartment comprising:
a heating, ventilation and air-conditioning housing having at least one inlet and plurality of outlets in communication with said housing;
a plurality of air ducts, each air duct having a cross-sectional area, said air ducts further including an inlet end connected to an outlet of said housing and a discharge end located in the interior compartment of the automotive vehicle, said air ducts delivering air from said housing to the vehicle interior;
a plurality of spaced apart noise reduction structures located on each of said air ducts between said housing end and said discharge end, the distance between said spaced apart noise reduction structures defining a length of air duct, whereby the length determines the particular frequency of noise to be reduced.

9. An air distribution apparatus for use with an automotive vehicle having an interior compartment as set forth in claim 8 wherein the spacing between respective spaced apart noise reduction structures and correspondingly the length of air duct between said noise reduction structures is unequal.

10. An air distribution apparatus for use with an automotive vehicle having an interior compartment as set forth in claim 8 wherein said plurality of noise reduction structures each have a cross-sectional area different from said cross-sectional area of said air duct.

11. An air distribution apparatus for use with an automotive vehicle having an interior compartment as set forth in claim 8 including said noise reduction structures spaced at a predetermined distance to reduce noise at a predetermined frequency.

12. An air distribution apparatus for use with an automotive vehicle having an interior compartment as set forth in claim 8 including said noise reduction structures spaced at a predetermined and unequal distance to reduce noise at more than one predetermined frequency.

13. An air distribution apparatus for use with an automotive vehicle having an interior compartment as set forth in claim 8 including a resonator communicating with at least one of said air ducts.

14. An air distribution apparatus for use with an automotive vehicle having an interior compartment as set forth in claim 1 including a resonator communicating with said air duct.

15. A method for reducing noise levels occurring in an air distribution apparatus used with an automotive vehicle having an interior compartment wherein the air distribution apparatus includes a heating, ventilation and air-conditioning housing having at least one inlet and at least one outlet in communication with the housing and at least one air duct having an inlet end connected to an outlet on the housing and a discharge end located in the vehicle interior whereby air is delivered from the housing to the vehicle interior through the air duct, said method comprising the steps of:
monitoring noise levels emanating from the discharge end of the air duct and determining the frequency of the emitted noise;
forming a plurality of spaced apart noise reduction structures in the air duct; and
determining the spacing between adjacent noise reduction structures based on the frequency of the emitted noise.

16. A method for reducing noise levels occurring in an air distribution apparatus used with an automotive vehicle having an interior compartment as set forth in claim 15 wherein the step of forming a plurality of spaced apart noise reduction structures in the air duct includes changing a cross section of said air duct such that the cross-sectional area of the air duct at a certain location along the air duct differs from the cross-sectional area of the air duct.

17. A method for reducing noise levels occurring in an air distribution apparatus used with an automotive vehicle having an interior compartment as set forth in claim 16 wherein the step of changing the cross section of said air duct includes reducing the cross-sectional area of said air duct.
